(19) United States
(12) Patent Application Publication
(10) Pub. No.: US 2026/0169440 A1
(43) Pub. Date: Jun. 18, 2026

(54) METHOD FOR MANUFACTURING AN OSCILLATING MEMBER

(71) Applicant: NIVAROX-FAR S.A., Le Locle (CH)

(72) Inventors: Geoffrey CHASSIN, Morteau (FR); Pierre CUSIN, Villars-Burquin (CH)

(73) Assignee: NIVAROX-FAR S.A., Le Locle (CH)

(21) Appl. No.: 19/386,950

(22) Filed: Nov. 12, 2025

(30) Foreign Application Priority Data
Dec. 13, 2024 (EP) 24219888.5

(51) Int. Cl. G04D 3/00; G04D 7/10

(52) U.S. Cl. CPC G04D 3/0069; G04D 7/10

(57) ABSTRACT

A method for manufacturing an oscillating member having a structural characteristic with a predetermined value, the method including a determination step (31) in which a value of a structural characteristic of an oscillating member (2) formed in a plate (1a, 1b) is determined from a generation substep (39) in which this value is generated on the basis of a predictive algorithm applied by a computer (8) to process at least one characteristic of an identified resonance frequency of the oscillating member (2) when it is exposed to vibratory excitation in an optical measurement substep (38) and a modification step (42) in which the dimensions of the oscillating member (2) are modified on the basis of a dimensional correction calculated on the basis of the value of the determined structural characteristic.

### CROSS-REFERENCE TO RELATED APPLICATIONS

This application claims priority to European Patent Application No. 24219888.5 filed Dec. 13, 2024, the entire contents of which are incorporated herein by reference.

### TECHNICAL FIELD OF THE INVENTION

The present invention relates to the field of parts manufacturing for the horology industry. The invention relates more specifically to a method for manufacturing an oscillating member having a structural characteristic, such as stiffness, with a predetermined value.

### TECHNOLOGICAL BACKGROUND

In the prior art, it is common to use methods for manufacturing oscillating members in plates, which involve engraving techniques such as laser engraving, plasma engraving, deep reactive ion etching (DRIE) or wet engraving.

However, it has been found that using such methods typically generates geometric dissipation between the oscillating members, all of which are formed in the same pattern on the same plate.

To remedy these drawbacks, solutions have been proposed in the prior art, in particular in patents EP 3181938 and EP 3181939, which describe methods for manufacturing balance springs.

In patent EP 3181938, the manufacturing method comprises the following steps: a) a balance spring is formed in dimensions greater than those required to obtain a balance spring with a predetermined stiffness, b) the stiffness of the balance spring formed in step a) is determined by measuring the frequency of the balance spring coupled with a balance with a predetermined inertia, c) the thickness of material to be removed in order to obtain the balance spring with a predetermined stiffness is calculated, and d) the calculated thickness of material is removed from the balance spring formed in step a), where steps b), c) and d) can be repeated in order to further improve the dimensional quality.

In patent EP 3181939, the manufacturing method comprises the following steps: a) a balance spring is formed in dimensions smaller than those required to obtain a balance spring with a predetermined stiffness, b) the stiffness of the balance spring formed in step a) is determined by measuring the frequency of the balance spring coupled with a balance with a predetermined inertia, c) the thickness of material missing in order to obtain the balance spring with a predetermined stiffness is calculated, and d) the balance spring formed in step a) is modified to compensate for the missing material thickness, where steps b), c) and d) can be repeated in order to further improve the dimensional quality.

Such methods can be improved, particularly in order to limit plate contamination that can occur during the measuring operations.

Under these circumstances, there is clearly a need to find solutions that will lead to such an improvement.

### SUMMARY OF THE INVENTION

The present invention aims to provide a method for manufacturing an oscillating member that meets the above needs.

The invention relates to a method for manufacturing an oscillating member having a structural characteristic with a predetermined value, the method comprising the following steps:
a) forming, in a plate, said oscillating member according to dimensions that are different to the dimensions necessary to obtain said oscillating member having the structural characteristic of the predetermined value;
b) determining a value of a structural characteristic of the oscillating member in the plate from a generation substep in which this value is generated on the basis of a predictive algorithm applied by a computer to process at least one characteristic of an identified resonance frequency of the oscillating member when it is exposed to vibratory excitation in an optical measurement substep;
d) calculating a dimensional correction to be applied to said oscillating member formed, on the basis of the value of the structural characteristic determined;
e) modifying the dimensions of said oscillating member formed, on the basis of the dimensional correction calculated to obtain the oscillating member with dimensions smaller than the dimensions necessary to obtain said oscillating member having the structural characteristic of the predetermined value.

In other embodiments:
the determination step comprises an arrangement substep in which the oscillating member comprised in the plate is arranged in a device for determining a value of the structural characteristic of the oscillating member;
the arrangement substep comprises a determination phase in which a measurement portion of the oscillating member capable of providing a significant vibratory response when the oscillating member is exposed to vibratory excitation is determined;
the arrangement substep comprises a positioning phase in which the oscillating member is positioned in the optical measurement module, in particular between a laser source and a photodiode light sensor;
the arrangement substep comprises a positioning phase in which the oscillating member is positioned relative to the generator module;
the determination step comprises a configuration substep in which a circular beam capable of being emitted by the laser source is configured by focusing it on a rim of the oscillating member;
the determination step comprises an application substep in which a time-varying vibratory excitation is applied to the oscillating member;
this substep provides for an application to the oscillating member of an excitation signal with an amplitude sufficient to induce this vibratory excitation and to be accurately detected and measured by the optical measurement module;
in the optical measurement substep, the computer connected to the optical measurement module determines at least one characteristic of the resonance frequency on the basis of data comprising the amplitude and oscillation phase spectra for the displacement of a blade on the oscillating member according to an excitation frequency;
the calculation step comprises a determination substep for determining, on the basis of this value of the determined structural characteristic, a thickness of material to be added to or removed from at least one dimension of this oscillating member formed in the formation step in order to obtain the oscillating member having the structural characteristic with a predetermined value.

### BRIEF DESCRIPTION OF THE FIGURES

Other features and advantages of the invention will be more clearly apparent from reading the following description of particular embodiments of the invention, provided merely as illustrative and non-limiting examples, and from the appended figures, among which:

FIG. 1 is a flowchart relating to a method for manufacturing an oscillating member having a structural characteristic with a predetermined value, according to the embodiments of the invention;

FIGS. 2 and 3 are schematic views of two different plates, each comprising a set of oscillating members that were formed at the same time, in particular by engraving, all in these plates, according to the embodiments of the invention;

FIGS. 4 and 5 are schematic views of first and second variants of a device for determining a value of the structural characteristic of the oscillating member comprising an element for generating a vibratory excitation in the body of this element which is in mechanical contact with one part of the plate comprising an attachment end of this oscillating member, and a module for optical measurement of at least one characteristic of an identified resonance frequency of the oscillating member, according to the embodiments of the invention;

FIG. 6 is a schematic view on a larger scale of part A of the plate shown in FIG. 3 comprising an oscillating member, according to the embodiments of the invention;

FIG. 7 is a schematic view of a third variant of a determination device comprising an element for generating this vibratory excitation in the body of the oscillating member which is not in mechanical contact with the part of the plate comprising an attachment end of this oscillating member, and the module for optical measurement of at least one characteristic of an identified resonance frequency of the oscillating member, according to embodiments of the invention, and

FIG. 8 is a schematic view of the module for optical measurement of at least one characteristic of an identified resonance frequency of the oscillating member, according to the embodiments of the invention.

### DETAILED DESCRIPTION OF THE INVENTION

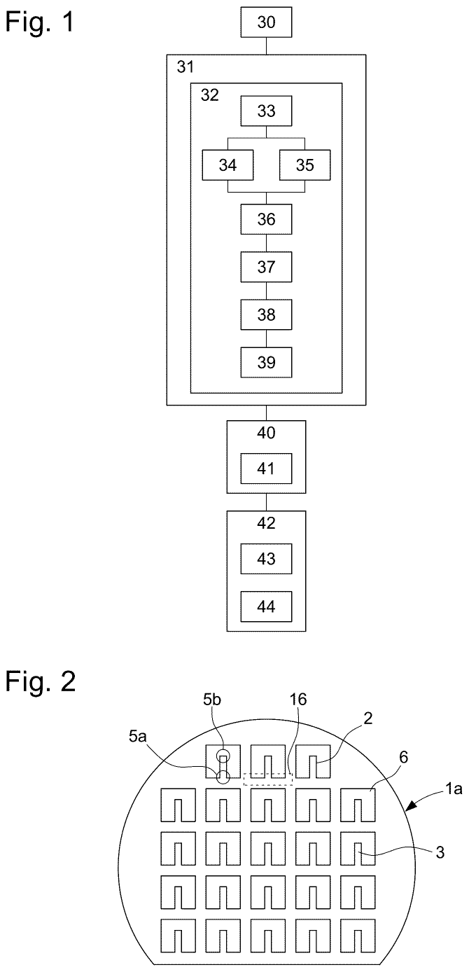

FIG. 1 is a schematic view of the method for manufacturing an oscillating member 2 having a structural characteristic with a predetermined value. Such a method aims to ensure very high dimensional precision of the manufactured oscillating members 2 and, incidentally, to guarantee a more precise structural characteristic of these oscillating members 2.

In this method, the oscillating member 2 is configured to vibrate at a stable frequency despite changes in certain parameters relating in particular to the setting and to the manufacturing process. This stable frequency varies according to at least one structural characteristic. Such a structural characteristic is defined in particular by intrinsic vibratory characteristics, such as resonance frequencies. Each resonance frequency of the oscillating member 2 exposed to an exciting force is a frequency at which a local maximum of displacement amplitude in the plane of the plate 1a, 1b can be measured in a given portion of this oscillating member 2. In other words, if the oscillating member 2 is excited with a time-varying frequency excitation source, the displacement amplitude follows an upward slope before this resonance frequency, and follows a downward slope thereafter in this portion. Typically, in such a test, recording the displacement amplitude in relation to the excitation frequency shows a displacement amplitude peak or resonance peak that is associated with or characterises the resonance frequency.

In this respect, such a structural characteristic can be stiffness, blade thickness or even the elastic couple.

It should be noted that in one embodiment, this oscillating member 2 can be a beam, a measurement structure, a specimen or even a mechanical resonator designed in particular to equip a regulating organ in a watch that is in the form of a silicon balance spring designed to equip a balance in a mechanical horology movement.

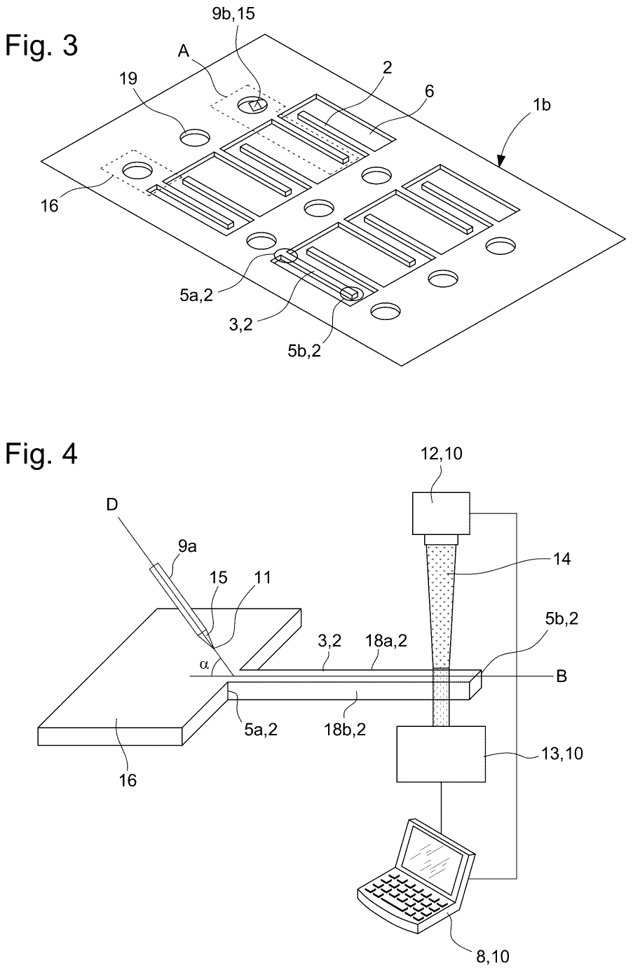

In FIGS. 2 and 3, a set of oscillating members 2 is comprised in a plate 1a, 1b, each of these oscillating members 2 having the general shape of a beam. In this set, each oscillating member 2 comprises an elastically flexible part. As has been previously mentioned, this member can be a horological balance spring and in this case, it comprises an elastically flexible strand connected at one end to a collet and which is wound in a spiral so as to form several consecutive turns, the last of which is extended by an attachment segment designed to be attached to a fixed balance bar, for example by means of a balance spring stud.

Referring to FIG. 1, such a method comprises a formation step 30 in which the set of oscillating members is formed in the plate 1a, 1b. In this set, each oscillating member 2 has dimensions that are different to the dimensions of the oscillating member 2 to be manufactured and has a structural characteristic with a predetermined value. Referring now to FIG. 3, the plate 1b comprises a through hole 20 formed in part 16 of the plate 1b, said part 16 comprising an attachment end 5a for attaching the oscillating member 2 to the plate 1b.

In this step 30, the oscillating members 2 are formed in the plate 1a, 1b of material, preferably simultaneously. Each oscillating member 2 can be formed in the plate 1a, 1b by engraving, for example by deep reactive ion etching, by laser engraving, by chemical engraving or by engraving using a focused ion beam. It should be noted that in the plate 1a, 1b, the oscillating members 2 in the set preferably have similar geometries.

The oscillating member 2 formed in this plate 1a, 1b comprises at least one blade 3. Referring now to FIG. 8, this blade 3 has a section 4 with dimensions E, H characterised by a height H and a thickness E of this section 4 when such a blade 3 is polygonal in shape—which are different to the corresponding dimensions of the oscillating member 2 to be obtained for which the structural characteristic has a predetermined value. In other words, the blade 3 on this oscillating member 2 can have a section 4 in which the dimensions E, H are greater or smaller than the corresponding dimensions of the section 4 of the blade 3 on the oscillating member 2 to be obtained and for which the structural characteristic has a predetermined value.

In plate 1a, 1b, blade 3. This oscillating member 2 comprises an attachment end 5a and at least one free end 5b. Each oscillating member 2 is comprised in a through opening 6 made in the plate 1a, 1b. This opening 6 forms a space in which the oscillating member 2 can freely execute a controlled mechanical oscillating movement in the plane of the plate 1a, 1b.

In the context of this method, the plate 1a, 1b is preferably made of doped or undoped silicon. This silicon can be monocrystalline, polycrystalline or amorphous silicon. Moreover, this silicon can have a {1,1,1}, {−1,1,1}, {1,1,1} or {−1,−1,1} orientation. Alternatively, the plate 1a, 1b can be manufactured from glass, ceramic, carbon nanotubes, quartz, metal or an alloy.

This method then comprises a determination step 31 in which a value of the structural characteristic of the oscillating member 2 formed in the plate 1a, 1b is determined. In this step 31, the method uses a device 7 to determine this value.

This determination device 7 comprises, in a non-limiting and non-exhaustive manner:
a computer 8;
a module 9a, 9b, 9c generating a time-varying vibratory excitation in the body of the oscillating member 2;
an optical measurement module 10 for measuring at least one characteristic of an identified resonance frequency of the oscillating member 2, comprising a laser source 12 and a photodiode light sensor 13.

The computer 8 in this determination device is connected to the generator module 9a, 9b, 9c and to the optical measurement module. This computer 8 comprises at least one processor and memory elements. This computer 8 is capable of executing instructions for executing a computer program 8 designed, for example, to drive/test the drive and measurement modules as well as the calculation/processing operations in which at least one predictive algorithm stored in the memory elements is implemented. This algorithm can comprise a machine learning algorithm and/or mathematical formulas. This algorithm is capable of implementing a predictive model or a simulation model enabling the value of the structural characteristic of the oscillating member 2 comprised in the plate 1a, 1b to be determined on the basis of the measurement of at least one characteristic of an identified resonance frequency of this oscillating member 2 exposed to vibratory excitation.

It should also be noted that a predictive model implemented by this algorithm is, as a general principle, configured to receive resonance frequency characteristics as an input and to provide the structural characteristic as an output.

In this device 7, the generator module 9a, 9b, 9c can transmit this vibratory excitation to the body of the oscillating member 2 when it is in mechanical contact with a part 16 of the plate 1a, 1b comprising the attachment end 5a of this oscillating member 2 or ideally without being in contact with this part 16.

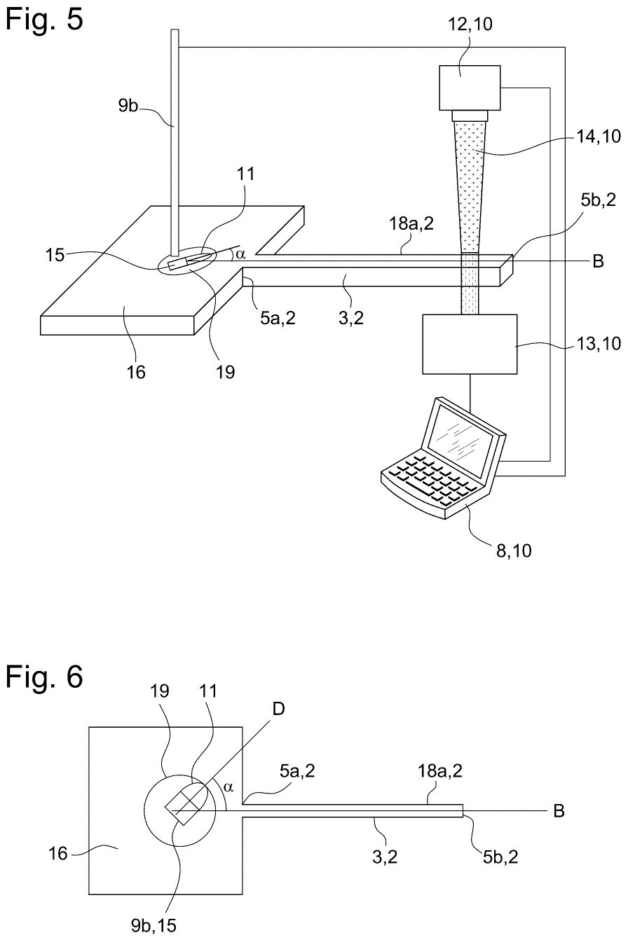

When this generator module 9a, 9b is in mechanical contact with the plate 1a, 1b for producing a vibratory excitation of the body of this oscillating member 2, it comprises an organ 15 for transmitting this vibratory excitation that is provided with a mechanical contact end 11 that can be pointed in the shape of a hand, in a first variant shown in FIG. 4, or in a second variant shown in FIGS. 3, 5 and 6, with a contact end 11 that can be rounded in the shape of a half-sphere or of a cone. Such an end is preferably made of a material that limits the potential damage that could be caused to the plate 1a, 1b, such as ceramic. This transmission organ 15 is then configured to generate a vibratory excitation to the oscillating member 2 so as to drive the body of the latter in a mechanical oscillating movement around its stable equilibrium position. It should be noted that this transmission organ 15 is capable of generating such vibratory excitation using piezoelectric technology.

When this generator module 9c is not in mechanical contact with the plate 1a, 1b, it is then configured to generate pulsating air 17 towards the oscillating member 2 so as to drive the body of this oscillating member 2 in a mechanical oscillating movement around its stable equilibrium position.

This determination step 31 comprises an arrangement substep 32 in which the blade 3 on the oscillating member 2 comprised in the plate 1a, 1b is arranged in the determination device 7. In this substep 32, the blade 3 on the oscillating member 2 is positioned relative to both the optical measurement module 10 and to the generator module 9a, 9b, 9c.

This arrangement substep 32 comprises a determination phase 33 in which a measurement portion 20 of the blade 3 on the oscillating member 2 is determined. In this phase 33, several measurements are made of the vibratory wave displacement in the body of the blade 3 on various portions of the blade 3 to identify the measurement portion 20 that is likely to provide a significant vibratory response when the body of the blade 3 is exposed to vibratory excitation. In fact, such a phase 33 is necessary because when the blade 3 is exposed to vibratory excitation, the latter can comprise portions in which the vibratory displacement amplitude is low or even zero, especially if the frequency varies over time. In the present embodiment, this measurement portion 20 is located in the third of the body of the blade 3, which comprises the free end 5b of this blade 3. When measuring a regulating organ that is not straight, it is important to avoid measuring in vibration nodes in the structure.

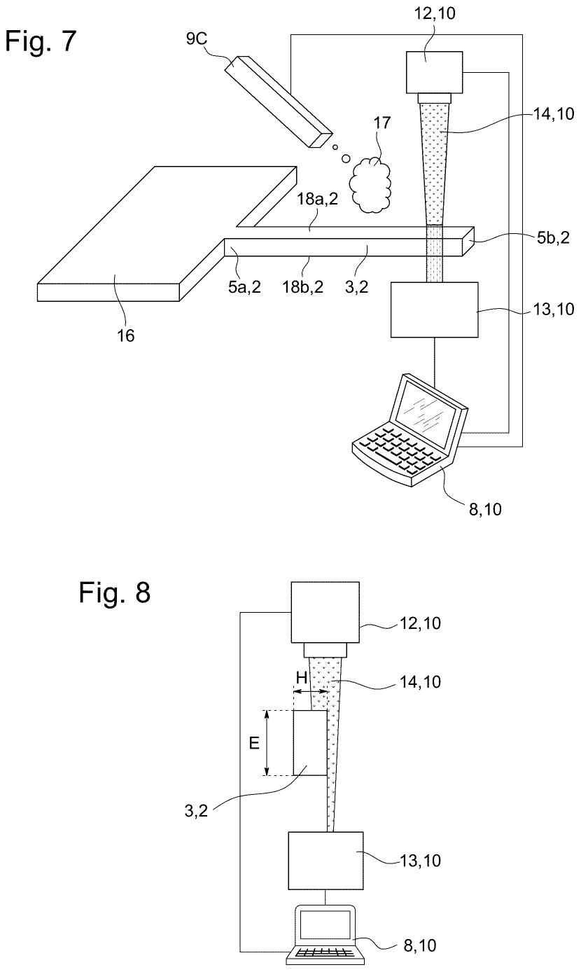

Thereafter, this arrangement substep 32 comprises a positioning phase 34 in which the measurement portion 20 of the blade 3 is positioned in the optical measurement module 10, in particular between the laser source 12 and the photodiode light sensor 13. Referring now to FIGS. 4, 5, 7 and 8, the laser source 12 is arranged facing an upper face 18a of the blade 3 and the photodiode light sensor 13 is positioned facing a lower face 18b of the blade 3. In this configuration, the laser source 12 is aligned with the photodiode light sensor 13.

This substep 32 comprises a positioning phase 35 in which the blade 3 on the oscillating member 2 is positioned relative to the generator module 9a, 9b, 9c. Indeed, when the transmission organ 15 in this generator module 9a, 9b is in mechanical contact with the plate 1a, 1b, its contact end 11 is then positioned so as to be in mechanical connection with the part of this plate 1a, 1b that comprises the attachment end 5a of the oscillating member 2.

In this case, the pointed end of the first variant of this transmission organ 15 is positioned in one of the zones of the part 16 defined on either side of the longitudinal axis of the blade 3 such that the contact interface between the surface of this zone and that of the pointed end is not arranged on this axis or immediately adjacent to this axis.

In the second variant of this transmission organ 15, it is positioned in the through hole 19 comprised in the part 16 comprising the attachment end 5a of the oscillating member 2. In this position, the end of this generator organ 9b is then in contact with a surface of a peripheral wall of this through hole 19.

In these first and second variants, the organ 15 is oriented towards the through opening 6 comprising this oscillating member 2, this direction forming an acute angle α with the longitudinal axis B of the blade 3 on either side of this axis B. Such an angle α is greater than or equal to 30 degrees, preferably comprised between 30 and 50 degrees, preferably 45 degrees.

As has already been mentioned, the transmission organ 15 in this generator module 9c can be contactless. In this configuration, this transmission organ 15 is positioned relative to the blade 3 so as to diffuse a pulsating air flow 17 towards the measurement portion of the blade 3 exposed to the beam 14 emitted by the laser source 12 of the optical measurement module 10.

This step 31 comprises a configuration substep 36 for configuring the circular beam 14 emitted by the laser source 12. More specifically, in this substep 36, the beam 14 is focused on a rim 21 of the blade 3, in particular an angular rim, located in the measurement portion 20, as shown in FIG. 8. Under these conditions, the diameter of the beam 14 is configured to take the dimensions of the measurement portion 20 of the blade 3 into account. This substep 36 thus helps improve the modulation of the luminous power of this laser beam 14 that is likely to be received by the photodiode light sensor 13, by the amplitude of the oscillations of the blade 3. In other words, the circular beam is focused so that the oscillation amplitude of the blade 3 in the plane of the plate 1a, 1b does not exceed the radius of this beam.

This determination step 31 then comprises an application substep in which a time-varying vibratory excitation 37 is applied to the oscillating member 2. In this substep 37, the generator module 9a, 9b, 9c applies to the blade 3 on this oscillating member 2 an excitation signal with an amplitude sufficient to induce this vibratory excitation and to be accurately detected and measured by the optical measurement module 10. This generator module 9a, 9b, 9c induces in:
a first mode, sustained vibratory excitation at a single given frequency, or
a second mode, vibratory excitation in the body of blade 3 at a time-varying frequency covering a predetermined frequency range. The entire frequency range can be scanned or covered in a given time interval;
a third mode, alternately or successively combining these first and second modes.

This step 31 comprises an optical measurement substep 38 in which at least one characteristic of an identified resonance frequency of the oscillating member 2 is measured, such as the value of this resonance frequency. In this substep 38, the luminous power received by the photodiode light sensor 13 is then measured in order to deduce the vibration amplitude in the measurement portion 20 of the blade 3. It should be noted that at the resonance frequency, this amplitude is at a maximum, so the power received by this light sensor 13 is at a maximum.

In this substep 38, the computer 8 connected to the laser source 12 and to the photodiode light sensor 13 determines at least one characteristic of the resonance frequency on the basis of data comprising the amplitude and oscillation phase spectra for the displacement of the blade 3 according to the excitation frequency; These data are generated by this computer 8 from a time-based recording of the oscillation amplitude and phase resulting from the beam 14 received by the light sensor 13.

Once said characteristic of this resonance frequency has been determined, the determination step 31 comprises a generation substep 39 in which a value of the structural characteristic of said oscillating member 2 comprised in the plate 1a, 1b is generated. In this substep 39, by executing the predictive algorithm, the computer 8 determines this structural characteristic on the basis of the resonance frequency characteristic.

The method then comprises a calculation step 40 in which a dimensional correction to be applied to the oscillating member 2 is calculated on the basis of the value of the structural characteristic determined for this oscillating member 2 comprised in the plate 1a, 1b. In this step 40, an estimated quantification of the dimensional correction to be applied to the oscillating member 2 is made.

To do so, this calculation step 40 comprises a determination substep 41 for determining, on the basis of this value of the determined structural characteristic, a thickness of material to be added to or removed from at least one dimension of this oscillating member 2 formed in the formation step 30 in order to obtain the oscillating member 2 having the structural characteristic with a predetermined value.

This dimensional correction effectively corresponds to a thickness of material to be removed from or added to the oscillating member 2 so as to vary at least one of its dimensions E, H, namely:
only the height H of its blade 3, or
only the thickness E of that blade 3, or
both this height H and this thickness E.

This dimensional correction can be made on one or more separate lengths of the blade 3 or over the entire length of the blade 3 on this oscillating member 2.

By determining the dimensional correction, such a substep 41 thus makes it possible to participate in shaping the geometry of this oscillating member 2, which will give it a structural characteristic substantially similar or similar to the structural characteristic with a predetermined value.

The method then comprises a modification step 42 in which the dimensions E, H of the oscillating member 2 are modified on the basis of a dimensional correction calculated to obtain the oscillating member 2 having a structural characteristic with a predetermined value.

In this case, if the dimensions E, H of this formed oscillating member 2 are greater than the dimensions required to obtain the oscillating member 2 to be manufactured, this step 42 comprises a removal substep 43 in which material is removed according to the calculated thickness of material to be removed. This removal can then be carried out using a process of oxidation followed by deoxidation of this oscillating member 2, which is well known in the prior art. Such a substep 43 aims to reduce the dimensions of the section 4 of the blade 3 on this oscillating member 2 over a given length or over the entire length of this blade 3.

If the dimensions E, H of the oscillating member 2 are less than the dimensions necessary to obtain the oscillating member 2 to be manufactured, this step 40 then comprises an addition substep 44 in which material is added according to the calculated thickness of material to be added. This material can then be added using methods known in the prior art, such as thermal oxidation, galvanic growth, physical vapour phase deposition, chemical vapour phase deposition, atomic layer deposition or any other additive process. Such a substep 44 aims to increase the dimensions E, H of the section 4 of the blade 3 on this oscillating member 2 over a given length or over the entire length of this blade 3.

Such a method therefore makes it possible to correct, with high precision, dimensional errors in oscillating members manufactured using such methods involving photolithography and/or DRIE technologies.

### TERMINOLOGY

1a, 1b. Plate comprising at least one oscillating member
2. Oscillating member
3. Blade on the oscillating member
4. Section of the blade on the oscillating member with different dimensions to the ones corresponding to the section of the balance spring to be manufactured.
5a. Attachment end of the blade on the oscillating member
5b. Free end of the blade on the oscillating member
6. Through opening in the plate in which the oscillating member is arranged
7. Device for determining the value of a structural characteristic of an oscillating member
8. Computer
9a, 9b, 9c. Module generating a time-varying vibratory excitation in the body of the oscillating member
10. Module for optically measuring at least one characteristic of an identified resonance frequency of the oscillating member
11. Mechanical contact end of the generator module
12. Laser source
13. Photodiode light sensor
14. Beam from the laser source
15. Vibratory excitation transmission organ
16. Part of the plate comprising the attachment end
17. Pulsating air from the generator module
18a. Upper face of the blade
18b. Lower face of the blade
19. Through hole formed in the plate part
20. Blade measuring portion
21. Rim of the blade measuring portion

1. A method for manufacturing an oscillating member (2) having a structural characteristic with a predetermined value, the method comprising the following steps:
a) forming (40), in a plate (1a, 1b), said oscillating member (2) according to dimensions that are different to the dimensions necessary to obtain said oscillating member (2) having the structural characteristic of the predetermined value;
b) determining (31) a value of a structural characteristic of the oscillating member (2) in the plate (1a, 1b) from a generation substep (39) in which this value is generated on the basis of a predictive algorithm applied by a computer (8) to process at least one characteristic of an identified resonance frequency of the oscillating member (2) when it is exposed to vibratory excitation in an optical measurement substep (38);
d) calculating (40) a dimensional correction to be applied to said oscillating member (2) formed, on the basis of the value of the structural characteristic determined; and
e) modifying (42) the dimensions of said oscillating member (2) formed, on the basis of the dimensional correction calculated to obtain the oscillating member (2) with dimensions smaller than the dimensions necessary to obtain said oscillating member (2) having the structural characteristic of the predetermined value.

2. The method according to claim 1, wherein the determination step (31) comprises an arrangement substep (32) wherein the oscillating member (2) comprised in the plate (1a, 1b) is arranged in a device (7) for determining a value of the structural characteristic of the oscillating member (2).

3. The method according to claim 1, wherein the arrangement substep (32) comprises a determination phase (33) wherein a measurement portion (20) of the oscillating member (2) capable of providing a significant vibratory response when the oscillating member (2) is exposed to vibratory excitation is determined.

4. The method according to claim 1, wherein the determination step (31) comprises an arrangement substep (32) wherein the oscillating member (2) comprised in the plate (1a, 1b) is arranged in a device (7) for determining a value of the structural characteristic of the oscillating member (2), this arrangement substep (32) comprising a positioning phase (34) wherein the oscillating member (2) is positioned in the optical measurement module (10), in particular between a laser source (12) and a photodiode light sensor (13).

5. The method according to claim 1, wherein the determination step (31) comprises an arrangement substep (32) wherein the oscillating member (2) comprised in the plate (1a, 1b) is arranged in a device (7) for determining a value of the structural characteristic of the oscillating member (2), this arrangement substep (32) comprising a positioning phase (35) wherein the oscillating member (2) is positioned relative to the generator module (9a, 9b, 9c).

6. The method according to claim 1, wherein the determination step (31) comprises an arrangement substep (32) wherein the oscillating member (2) comprised in the plate (1a, 1b) is arranged in a device (7) for determining a value of the structural characteristic of the oscillating member (2), this arrangement substep (32) comprising a positioning phase (34) wherein the oscillating member (2) is positioned in the optical measurement module (10), in particular between a laser source (12) and a photodiode light sensor (13), this determination step (31) comprising a configuration substep (36) wherein a circular beam (14) capable of being emitted by the laser source (12) is configured by focusing it on a rim (21) of the oscillating member (2).

7. The method according to claim 1, wherein the determination step (31) comprises an application substep (37) wherein a time-varying vibratory excitation is applied to the oscillating member (2).

8. The method according to claim 1, wherein this substep (37) provides for an application to the oscillating member (2) of an excitation signal with an amplitude sufficient to induce this vibratory excitation and to be accurately detected and measured by the optical measurement module (10).

9. The method according to claim 1, wherein, in the optical measurement substep (38), the computer (8) connected to the optical measurement module (10) determines at least one characteristic of the resonance frequency on the basis of data comprising the amplitude and oscillation phase spectra for the displacement of a blade (3) on the oscillating member (2) according to an excitation frequency.

10. The method according to claim 1, wherein the calculation step (40) comprises a determination substep (41) for determining, on the basis of this value of the determined structural characteristic, a thickness of material to be added to or removed from at least one dimension of this oscillating member (2) formed in the formation step 30 in order to obtain the oscillating member (2) having the structural characteristic with a predetermined value.
